(19) United States
(12) Patent Application Publication
(10) Pub. No.: US 2010/0084050 A1
(43) Pub. Date: Apr. 8, 2010

(54) Lead-Free Solder with Improved Properties at Temperatures >150°C

(75) Inventors: Winfried Kraemer, Bad Orb (DE); Joerg Trodler, Erlensee (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: W.C. HERAEUS GMBH, Hanau (DE)

(21) Appl. No.: 12/444,283

(22) PCT Filed: Oct. 5, 2007
(86) PCT No.: PCT/EP07/08635

§ 371 Date: Apr. 16, 2009

(30) Foreign Application Priority Data
Oct. 6, 2006 (DE) 10 2006 047 764.2

(51) Int. Cl. B23K 35/26; B23K 35/24

(52) U.S. Cl. 148/23

(57) ABSTRACT

Lead-free solders based on an Sn—In—Ag solder alloy contain 88 to 98.5 wt. % Sn, 1 to 10 wt. % In, 0.5 to 3.5 wt. % Ag, 0 to 1 wt. % Cu, and a doping with a crystallization modifier, the crystallization modifier preferably being a maximum of 100 ppm neodymium.

### CROSS-REFERENCE TO RELATED APPLICATIONS

This application is a Section 371 of International Application No. PCT/EP2007/008635, filed Oct. 5, 2007, which was published in the German language on Apr. 17, 2008, under International Publication No. WO 2008/043482 A1 and the disclosure of which is incorporated herein by reference.

### BACKGROUND OF THE INVENTION

The present invention relates to a solder for objects whose use range lies up to 200° C., in particular 150 to 190° C.

At these high temperatures, tin-silver-copper (SAC) solder points age particularly quickly due to the growth of intermetallic phases. The tensile strength is lower at high temperatures and the permanent elongation limit worsens due to the material fatigue, which follows in association with the growth of the intermetallic phases.

According to EU guidelines 2002/96/EG “Waste Electrical and Electronic Equipment” (WEEE) and 2002/95/EG “Restriction of the use of certain hazardous substances in electrical and electronic equipment” (RoHS) (http://ec.europa.eu/environment/waste/weee_index.htm), the use of lead-containing solders is considerably restricted and the use of lead-free solders is essentially prescribed. Solders with a lead content up to 0.1 wt. % are considered lead free.

U.S. Pat. No. 5,938,862 discloses an SAC solder having 8 to 10 wt. % indium with 2.3 wt. % Ag and 1 wt. % copper. The high indium content makes the solder alloys very soft, and deformations (holes) appear, so that these indium alloys are not suitable for the production of solder balls for chip fabrication.

German published patent application DE 10 2004 050 441 A1 discloses the use of lanthanides in combination with iron metals, in order to delay material coarsening due to thermal effects. It is assumed that neodymium, which is advantageously introduced as an iron metal master alloy, is defined as a corresponding intermetallic phase by the master alloy, because the Misch metal used there could not be alloyed conventionally due to its high affinity to oxygen.

Concerning problems in the formation of slag, as happens, for example, with the introduction of neodymium, European Patent Application Publication EP 1 623 791 A2 describes a method for its separation. Thus, for example, solders can be purified according to International Patent Application Publication No. WO 03/051572 A1. WO 03/051572 describes an indium-containing SAC solder, with which neodymium is optionally alloyed. At 5 to 20 wt. % silver, a nearly eutectic alloy is generated. This has the advantage that the alloy solidifies in a nearly abrupt manner and in this way a smooth surface is formed. The high silver content leads to a high portion of Ag₃Sn phases that continue to grow under temperature loading and that would coarsen the structure.

WO 03/051572 A1 discloses a lead-free solder based on an SAC alloy having 0.8 to 1.2 wt. % indium and 0.01 to 0.2 wt. % neodymium. This solder should avoid the formation of coarse tin dendrites and should guarantee a smooth and homogeneous surface of the solder after melting. Furthermore, the solder should have the highest possible fatigue limit under completely reversed stress, so that even materials with very different thermal expansion coefficients could be joined to each other with this solder.

WO 97/43456 is directed toward the problem of material fatigue due to changes in temperature in the automotive field. A lead-free solder is described made from 68.2 to 91.8 wt. % tin, 3.2 to 3.8 wt. % silver, and 5 to 5.5 wt. % indium, wherein this solder optionally has up to 3 wt. % bismuth and up to 1.5 wt. % copper. As an example, an alloy is listed with 89.8 wt. % tin, 3.7 wt. % silver, 5 wt. % indium, and 1.5 wt. % copper.

### BRIEF SUMMARY OF THE INVENTION

The object of the present invention lies in counteracting the material fatigue that occurs at temperatures up to 200° C., particularly in the range between 150 and 190° C.

The melting point of the solder should lie at least 10° C., preferably 20° C., above the maximum use temperature.

The object is achieved by a lead-free solder based on an Sn—In—Ag solder alloy containing
88 to 98.5 wt. % Sn,
1 to 10 wt. % In,
0.5 to 3.5 wt. % Ag,
0 to 1 wt. % Cu,
and a doping with a crystallization modifier inhibiting the growth of intermetallic phases in the solidified solder.

In a preferred embodiment a leadfree solder based on an Sn—In—Ag solder alloy contains:
88 to 98.5 wt % Sn,
1 to 8 wt % In,
0.5 to 3.5 wt % Ag,
0 to 1 wt % Cu,
0 to 3 wt % Ga, Sb, Bi in total,
up to 1 wt % additives or impurities, and
a doping with a crystallization modifier.

It is significant for the present invention that a solder based on a tin-indium-silver alloy blocks the formation and the growth of intermetallic phases. According to one embodiment of the invention, the mass portions of the components of tin, indium, silver, and optionally copper are selected so that, due to this composition, there is just a small tendency for the formation and growth of intermetallic phases. In addition, the formation of intermetallic Ag₃Sn phases is blocked, particularly their growth leading to material coarsening in a preferred direction.

According to another embodiment of the invention it was recognized that the lanthanides, provided in the prior art for grain refinement, can indeed be used for the solidification of the solder, but the solder properties are affected for lanthanide concentrations, particularly for Nd concentrations, greater than 100 ppm. The applied quantities always lie above the solubility limits of lanthanides, particularly neodymium in tin, so that the lanthanides, particularly neodymium, are always present in intermetallic phases. Intermetallic phases, however, are susceptible to oxidation, particularly at high application temperatures and would therefore lead to a large number of problems at high application temperatures, which is why such phases are to be avoided for solders that are exposed to temperatures greater than 150° C.

According to a further embodiment of the invention, on one hand, the formation of metallic phases is kept small and, on the other hand, the crystallization of the intermetallic phases is modified. Higher copper or silver portions increase the formation of intermetallic phases. Here, it is significant that, between 1 and 8 wt. % indium, particularly between 1.5 and 5 wt. % indium, the formation of a Cu₃Sn phase for the application of the solder on a Cu surface is significantly restricted. It is further significant that the crystallization growth is modified. Both effects slow material fatigue at high temperatures; in particular, so far as the silver content is limited to a maximum of 3.5 wt. %, in particular 3 wt. %.

For modifying the crystal growth of the Ag₃Sn phases, according to an embodiment of the invention a crystallization modifier is used, in particular neodymium. Neodymium can effectively modify crystal growth as a modifier in an amount less than the ICP detection limit of 30 ppm. Neodymium therefore needs to be doped only in quantities of less than 100 ppm, in particular less than 30 ppm, in the solder. If the neodymium is dissolved in the matrix, due to its low concentration, it blocks the formation of intermetallic phases, so that these form, if at all, with a star shape.

It is suspected that the neodymium dissolved in the matrix is taken up by the resulting intermetallic neodymium phases with a neodymium concentration of over 100 ppm, and therefore at higher concentrations in the vicinity of the intermetallic neodymium phases, no more is dissolved in the matrix. It is assumed that, with the increase of the neodymium concentration, the formation of intermetallic phases increases instead of decreases with a neodymium concentration over 100 ppm.

The modification of the crystal growth, particularly with neodymium, lies in that, instead of coarse crystal plates or needles, fine, branched crystals are produced at temperatures above 150° C. in the solidified solder, i.e., below its melting point.

This effect is very important with the increasing miniaturization of solder connections, e.g., in chip fabrication, particularly for wafer bumping. Particularly under operating conditions at temperatures above 150° C., increasing portions of Sn from the solder compound are bound, due to the phase growth of the Cu₃Sn or Cu₆Sn₅ phases, in the boundary surfaces. The necessarily increasing Ag portion in the remaining solder leads to a strong crystal growth of the Ag₃Sn phases, when the above-cited threshold of 3.0 wt. % is exceeded.

With the plate-shaped or needle-shaped formation of the Ag₃Sn phases, it is possible that the phases grow out of the solder compound and lead to short circuits. This is prevented by the Nd doping.

Finely branched crystal growth of Ag₃Sn phases therefore suggests neodymium, whose presence in homeopathic quantities below the detection limit of 30 ppm is sufficient. However, it is significant that the solder according to an embodiment of the invention be doped with a modifier, particularly neodymium. Natural impurities are not sufficient. Neodymium is compatible only up to approximately 100 ppm. The solubility limit of neodymium in tin lies below 100 ppm. In addition, neodymium separates in intermetallic tin-neodymium phases. Larger quantities of neodymium worsen the alloying, due to the separation of oxidized SnNd phases. 0.05 to 0.2 wt. % neodymium leads to an oxide skin on the solder surface, caused by the oxidation of neodymium under atmospheric conditions. To keep neodymium at a concentration of 0.01 wt. % in a melt, reducing conditions or the application of a vacuum would be necessary. An alloy with 0.2 wt. % neodymium cannot be processed to form solder powder with conventional fabrication processes and promotes crack formation through oxidized inclusions in the boundary surface of the solder point.

Also very important is the dosing of indium. Indium appears to decisively block the growth of the Cu₃Sn phase. For this purpose, between 1 to 2 wt. % indium is required in order to block the formation of Cu₃Sn phase significantly. With 1% indium and just below, the phase growth of the Cu₃Sn phase is similar to that of a pure SAC solder (Sn, Ag, Cu). At 1.75 wt. %, a significantly smaller phase growth of the Cu₃Sn phase has been found, and associated with this a longer high-temperature stability. Indium is the most expensive of all the components and is already used as sparingly as possible for this reason. Thus, the expensive cost effect in the range between 5 to 8 wt. % indium is relatively small. Above 8% indium, the melting point of the solder is too low for the high-temperature applications intended for the solders according to the invention. The tensile strength increases as a function of the indium content, whereby for this aspect, an indium content between 4 and 10 wt. %, particularly between 4 and 8 wt. %, can be justified.

The solders according to the invention have an outstanding resistance to temperature changes in use at temperatures starting at 150° C. Preferably, the melting point of solders according to the invention lies above 210° C., particularly above 215° C.

The mechanical strength to be expected in a solder alloy according to the invention will be described with sufficient accuracy with the following functions:

Maximum Tensile Strength: Rm in MPa:

Rm=16 MPa+4.3 MPa Ag [wt. %]+4.4 MPa In [wt. %]+10 MPa Cu [wt. %]

Permanent Elongation Limit Rp_{0.2} in MPa:

Rp_{0.2}=7 MPa+2.2 MPa Ag [wt. %]+4.8 MPa In [wt. %].

The strengths of the solder alloys were determined on cast tensile test bodies having a sample diameter of 3.2 mm and a measurement length of 15 mm. The test bodies were stored at room temperature for 6 weeks before testing.

The content of silver should amount to greater than 0.5 wt. %, preferably greater than 1 wt. %, so that the melting point of the solder is not too high and not too much indium is needed for lowering the melting point. Above 3.5 wt. % silver, the portion of Ag₃Sn phases is undesirably high. Silver should therefore be set in an amount between 0.5 and 3.5 wt. %, particularly between 1 and 3 wt. %. Optionally, copper could be contained up to 1 wt. %. At portions above 1 wt. %, Cu increasingly forms the undesired Cu₆Sn₅ phase, which grows undesirably quickly at high temperatures.

The content of tin should lie between 88 and 98.5 wt. %. Below 88 wt. %, the melting point becomes too low for high-temperature applications. Furthermore, the portions of Ag and Cu phases would increasingly or unnecessarily consume too much indium. Above 98.5 wt. %, the melting point becomes too high and the tensile strength too low.

The solders according to the invention tolerates up to 1% additive, in particular Ni, Fe, Co, Mn, Cr, Mo, or Ge and conventional impurities. In traces far below 1%, Nd could also be introduced as the most economical rare-earth metal mixture (e.g., in combination with Ce, La, or Pr). A possibly required adjustment of the melting point and strength of the solder is possible through the addition of up to 3% Sb or Bi or Ga, in order to spare the expensive In. Overall, the sum of elements Sb, Bi, and Ga should not exceed 3 wt. %. Because problems known from the use of lead could occur with respect to bismuth, it is recommended to avoid bismuth, at the least to leave its content below 0.1 wt. %.

The solders according to the invention allow more reliable electronics at application temperatures of the electronics in the range between 140 and 200° C., particularly between 150 and 190° C. or under high temperature-change conditions. The solders according to the invention increase the reliability of the power electronics and the high-temperature applications, particularly power electronics in high-temperature applications. As examples for the power electronics the following can be named: DCB (direct copper bonding), COB (chip on board), hybrid circuits, semiconductors, wafer bumping, SIP (system in packaging), and MCM (multi chip module), particularly stack package. The risk of electrical short circuits due to growth of Ag₃Sn phases in closely spaced solder connections, as in wafer bumping, is considerably reduced with solders according to the invention.

The temperature range between 140 to 200° C., particularly 150 to 190° C., is of considerable importance for electronic solder connections in machine construction, particularly vehicle construction, whereby increased security is ensured for electronics with solders according to the invention in machine and vehicle construction. Particularly in this field, in addition to temperature loads, the temperature-change stability is also important and improved with the solders according to the invention. The improved security with the solders according to the invention in the high temperature range is particularly important for the automotive, industrial electronics, rail vehicles, and aerospace fields. Especially, the electronics in the fields of motors, driving mechanisms, or brakes are already exposed to extreme temperature loading and should nevertheless exhibit maximum reliability, whereby in the case of power electronics, the heat generated by the electronics still negatively affects the reliability. The solders according to the invention will significantly contribute to alleviating problems in these technical fields. Furthermore, the solders according to the invention aid the reliability for increased security in electronics exposed to solar radiation, particularly electronics exposed to direct solar radiation, but also electronics impacted by indirect solar radiation.

Below, the invention will be illustrated with reference to examples according to Table 1 and the Figures.

TABLE 1

| | | | | | | | | | | | Strength of | |
|---|---|---|---|---|---|---|---|---|---|---|---|---|
| | | | | | | | | Melting range | | | casting | |
| | | | | | | | | Liquidus | Solidus | Sub- | Rp_{0.2} | Rm |
| Alloy No. | | Sn | Ag | Cu | In | Ga | Nd | [° C.] | [° C.] | cooling | [MPa] | [MPa] |
| Comparison | 1 | 96.500 | 3.50 | | | | | 221 | 221 | | 19 | 32 |
| Comparison | 2 | 96.500 | 3.00 | 0.50 | | | | 219.4 | 216.2 | | 18 | 35 |
| Comparison | 6 | 95.700 | 3.80 | 0.50 | | | | 216.7 | 215.8 | | | |
| Comparison | 7 | 95.500 | 3.80 | 0.70 | | | | | | | 19 | 41 |
| Comparison | 8 | 95.500 | 4.00 | 0.50 | | | | 217.9 | 216.8 | | 17.5 | 37.5 |
| Comparison | 9 | 91.500 | 4.00 | 0.50 | 4.00 | | | 210 | 206.5 | | | |
| Comparison | 10 | 88.500 | 4.00 | 0.50 | 7.00 | | | 205.1 | 202.2 | | | |
| Comparison | 11 | 92.300 | 5.50 | 1.00 | 1.00 | | 0.200 | 215.1 | eutectic | | | |
| Example | 1 | 95.490 | 2.00 | 0.50 | 2.00 | | 0.010 | 217.8 | 209.8 | + | | |
| Example | 5 | 94.995 | 2.50 | 0.50 | 2.00 | | 0.005 | 216.1 | 210.3 | + | | |
| Example | 6 | 94.495 | 3.00 | 0.50 | 2.00 | | 0.005 | 214.8 | 211.2 | + | | |
| Example | 7 | 93.695 | 3.80 | 0.50 | 2.00 | | 0.005 | 213.5 | 211.3 | + | | |
| Example | 8 | 94.745 | 2.50 | 0.75 | 2.00 | | 0.005 | 216.8 | 209.8 | + | 24.5 | 41.3 |
| Example | 9 | 97.245 | 0.00 | 0.75 | 2.00 | | 0.005 | 223.8 | 216.9 | + | 20.0 | 33.4 |
| Example | 10 | 95.500 | 2.50 | 0.00 | 2.00 | | <0.003 | 219.2 | 213.4 | + | 20.2 | 33.0 |
| Comparison | 3 | 96.990 | 2.50 | 0.50 | 0.00 | | 0.010 | 224.1 | 216.5 | + | 18.3 | 32.5 |
| Comparison | 4 | 95.990 | 2.50 | 0.50 | 1.00 | | 0.010 | 220.5 | 211.0 | + | 19.9 | 37.0 |
| Comparison | 5 | 95.000 | 2.50 | 0.50 | 2.00 | | 0.000 | 217.2 | 209.5 | − | 24.4 | 41.1 |
| Example | 2 | 93.990 | 2.50 | 0.50 | 3.00 | | 0.010 | 216.3 | 206.7 | + | 27.4 | 43.4 |
| Example | 3 | 92.995 | 2.50 | 0.50 | 4.00 | | 0.005 | 217.1 | 206.2 | + | 36.3 | 47.6 |
| Example | 4 | 89.950 | 2.50 | 0.50 | 7.00 | | 0.050 | 207.3 | 200.4 | + | 50.6 | 64.5 |
| Example | 11 | 94.500 | 2.50 | 0.50 | 2.50 | | 0.000 | 215.4 | 206.9 | − | 26.4 | 44.8 |
| Example | 12 | 95.250 | 2.50 | 0.50 | 1.75 | | <0.003 | 218.2 | 209.8 | − | 21.0 | 36.7 |
| Example | 13 | 95.000 | 2.80 | 0.20 | 2.00 | | 0.000 | 218.3 | 206.3 | − | 26.6 | 42.5 |
| Example | 14 | 94.695 | 2.70 | 0.40 | 2.20 | | 0.005 | 217.7 | 209.4 | + | 25.2 | 40.6 |
| Example | 15 | 94.695 | 2.50 | 0.50 | 2.00 | 0.30 | 0.005 | 215.8 | 207.8 | + | 27.6 | 44.1 |
| Example | 16 | 94.195 | 2.50 | 0.50 | 2.00 | 0.80 | 0.005 | 214.1 | 203.1 | + | 29.7 | 46.8 |

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a series of schematic diagrams illustrating the formation of Ag₃Sn phases of an SAC solder point on copper substrate in comparison to an SAC solder point containing In and doped with Nd according to the invention;

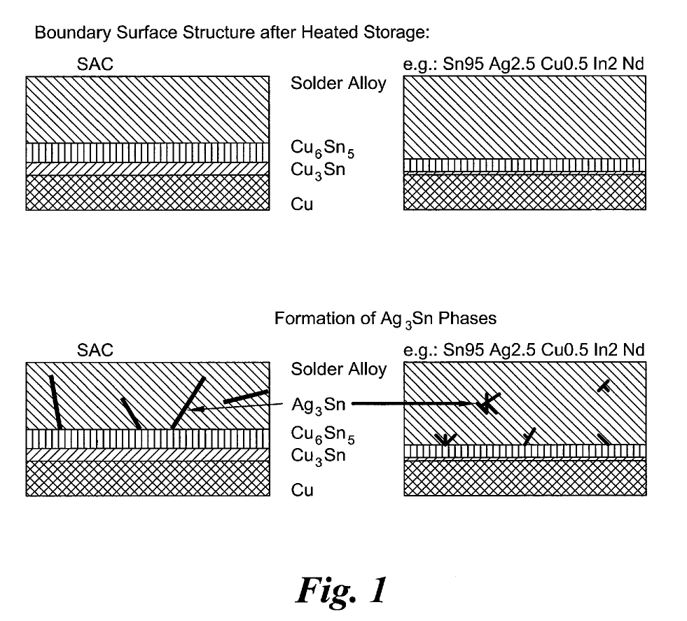

FIG. 2 is a series of microphotographs showing the Ag₃Sn phases formed with solders according to the invention in comparison to previously formed Ag₃Sn phases;

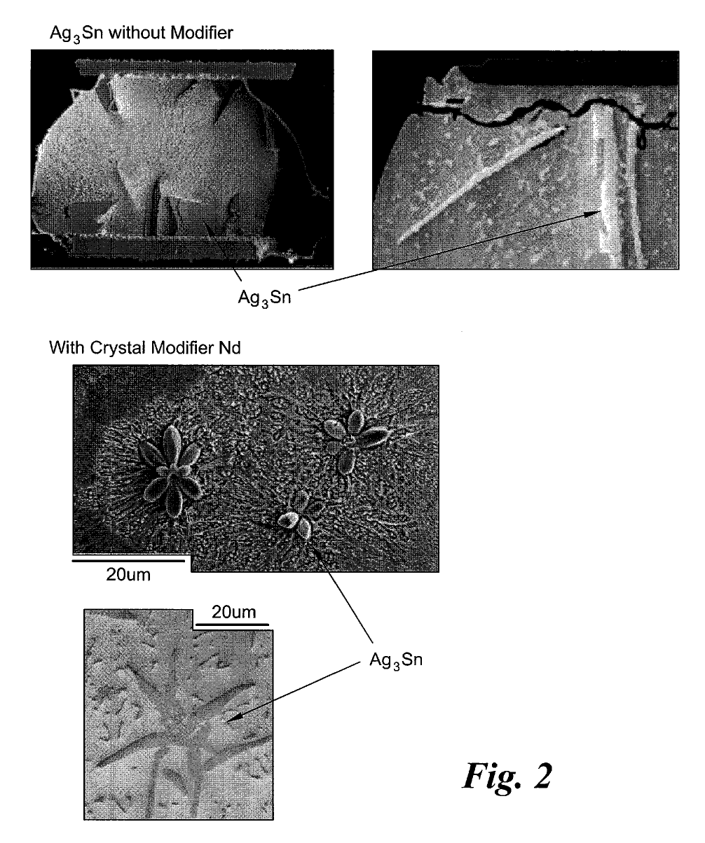

FIG. 3 is a graph showing the dependency of the tensile strength of test alloys on the indium content;

FIG. 4 is a graph showing the dependency of the melting range of test alloys on the indium content;

FIG. 5 is a series of microphotographs showing a comparison example with a formation of an intermetallic phase leading to a short circuit; and

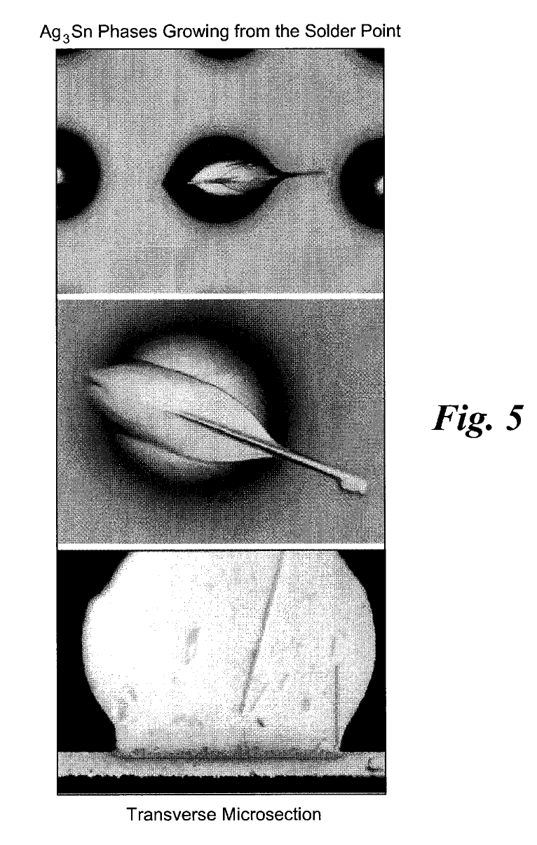

FIG. 6 are diagrams showing the susceptibility to oxidation of an intermetallic phase containing neodymium.

### DETAILED DESCRIPTION OF THE INVENTION

### Embodiment of a Production Method

For the production of a solder alloy according to the invention, it is advantageous to perform the Nd doping via a master alloy.

With the conventionally rather low melting temperatures of <500° C. for solder powder production, there arises the risk that elemental Nd introduced as a pure metal or rare-earth metal mixture floats, due to the low density, floats on the pre-melted solder and is immediately oxidized. In the form of neodymium oxide, it is no longer effective and accumulates in the slag.

To suppress this, the neodymium is doped via a master alloy with one or more components of the solder alloy. In this way, oxidation of the already alloyed neodymium is avoided and a uniform distribution of the crystal modifier is achieved.

Suitable master alloys include, e.g.:
Sn Nd 2-10
Cu Nd 10-20
Ag Nd 10-20
Ag Cu 10-40 Nd 5-15
(concentration ranges given in wt. %)

These master alloys can be easily produced with suitable melting methods. It has proven effective to alloy the neodymium at temperatures above 800° C., in order to achieve a homogeneous distribution, and the final master alloy has a melting point below 1000° C., preferably below 900° C. This guarantees trouble-free dissolving of the master alloy in the solder melt at <500° C.

### Comparison Example 1

Sn 96.5, Ag 3.5 has a permanent elongation limit Rp_{0.2} of 19 MPa and a tensile strength of 32 MPa. This alloy tends strongly toward growth of Ag₃Sn phases and therefore exhibits considerable material fatigue at temperatures above 150° C. Increasing silver content promotes the formation of Ag₃Sn phases.

### Comparison Example 2

Sn 96.5, Ag 3, Cu 0.5 has a permanent elongation limit of 18 MPa and a tensile strength of 35 MPa. Like the solder of Comparison Example 1, during the soldering process, this solder forms a pronounced Cu₃Sn layer on the surface of a copper base. The intermetallic Cu₃Sn phase grows and embrittles the boundary surface to the copper at temperatures above 150° C. and leads to material fatigue of the solder connection.

### Comparison Example 3

Sn 96.99, Ag 2.5, Cu 0.5, Nd 0.01 has a permanent elongation limit of 18.3 MPa and a tensile strength of 32.5. When this alloy melts, Cu₃Sn likewise forms on a copper track, which grows at temperatures above 150° C.

According to Comparison Example 4, an addition of 1 wt. % indium causes, compared with Comparison Example 3, an increase in the permanent elongation limit to 19.9 and an increase in the tensile strength to 37.0. With respect to the formation of the Cu₃Sn phase and the material fatigue associated with this phase at temperatures above 150° C., however, there is no significant difference compared with Comparison Example 3.

### Comparison Example 4

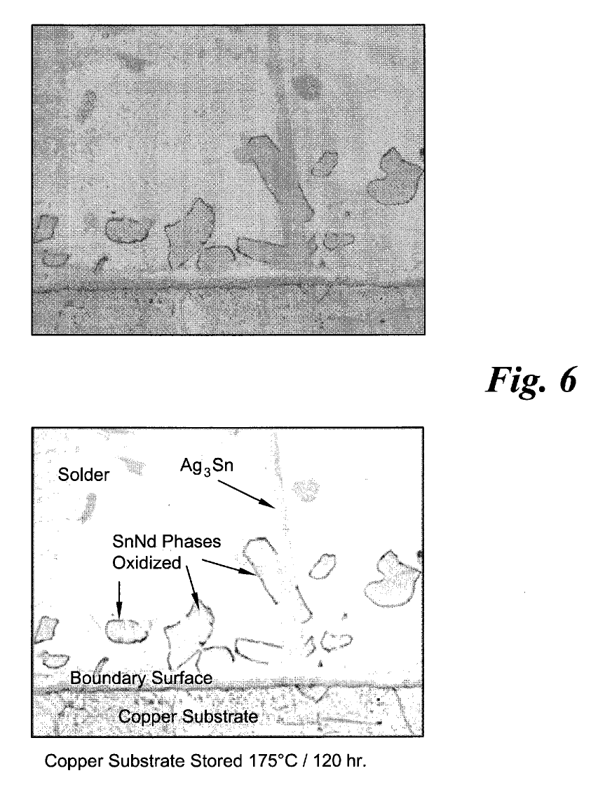

A solder with a neodymium content that forms an intermetallic phase ages quickly. FIG. 6 shows an intermetallic phase that contains neodymium and that was completely oxidized at the boundary surfaces due to removal from storage at 175° C. over a time period of 120 hours and, in this manner, exhibits a significant material fatigue, which is a starting point for further deterioration of the material.

### Invention Example 1

Sn 95.49, Ag 2, Cu 0.5, In 2, Nd 0.01 shows, in addition to further improved mechanical properties compared with Comparison Example 4, a suppressed formation of the Cu₃Sn phase and a lower growth of the same at temperatures above 150° C. With this example according to the invention, the material fatigue is drastically slowed down thereby with excellent mechanical properties.

If the doping with neodymium from Example 1 is discontinued according to Comparison Example 5, the formation of the Cu₃Sn phase is indeed small at the beginning, but the Ag₃Sn phase tends toward growth and the formation of coarse plates or needles at temperatures above 150° C. and therefore leads to unacceptable material fatigue and the risk of short circuit formation due to the crystal growth of Ag₃Sn.

### Invention Example 2

Example 2 with an increase in the indium concentration by 1%, compared with Example 1, causes further improved mechanical properties. The formation of the Cu₃Sn phase when soldered on a copper track is further reduced, compared with Example 1, and the material fatigue diminishes even more at temperatures above 150° C.

### Invention Example 3

A further increase of 1 wt. % indium according to Example 3 produces, in addition to more improved mechanical properties, no relevant decrease in the formation of the Cu₃Sn phase compared with Example 2. The material fatigue at temperatures above 150° C. is reduced compared with Example 2.

### Invention Example 4

With a further increase of 3 wt. % indium, compared with Example 3, further significantly improved mechanical properties are achieved, compared with Example 3. However, there is no significant reduction, compared with Examples 2 and 3, in the formation of the Cu₃Sn phase when soldering on a copper track. Indeed, there is still a slight improvement with respect to the material fatigue at temperatures above 150° C., compared with Example 3. For this, however, the solidus of the melt interval is already decreased to 200.4° C.

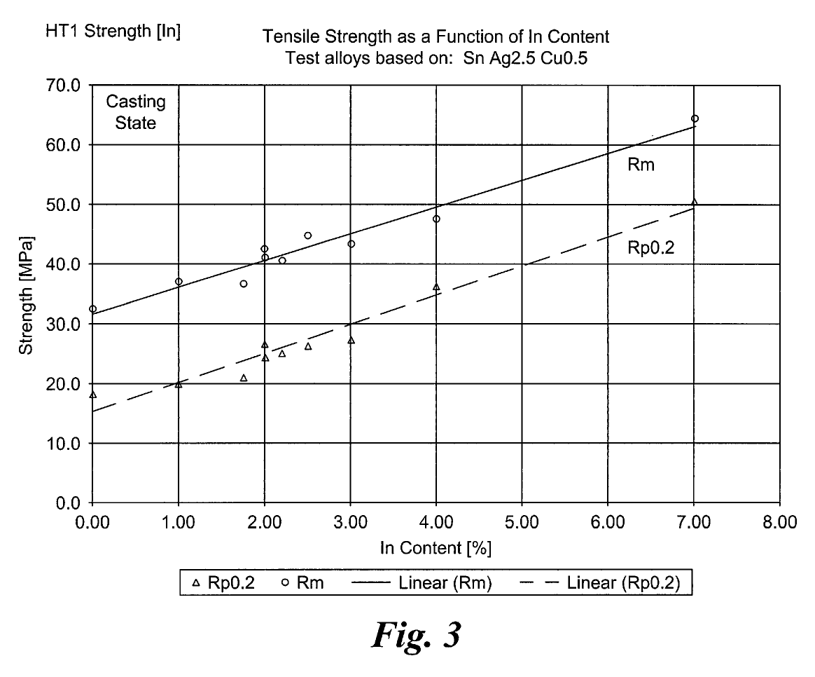

FIG. 3 shows the dependency of the melting range on the indium content of a solder on the basis of tin with 2.5 wt. % silver and 0.5 wt. % copper.

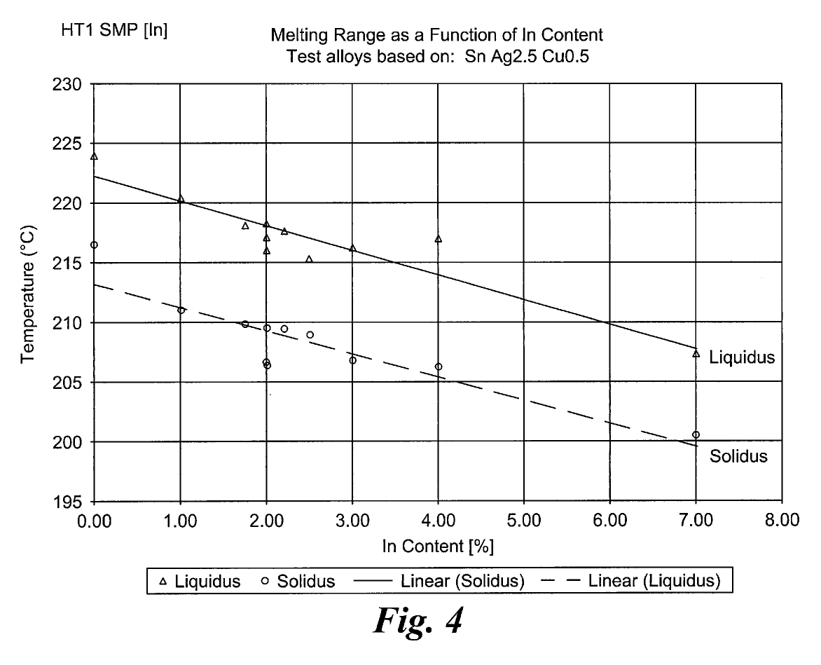

FIG. 4 shows the corresponding increase in the tensile strength.

With reference to Table 2, it is explained below how the growth of the Cu₃Sn phases is suppressed with In. The improved high-temperature stability is to be explained by the blocked phase growth of the Cu₃Sn phases.

Without In, the ratio of Cu₃Sn/Cu₆Sn₅ phases is about 1/2 after a heated storage of 175° C./120 hr. With 2% In, the ratio reduces to 1/3, whereby the total thickness of the CuSn phases in the boundary surface is reduced by about 45%.

TABLE 2
Layer thickness of CuSn phases after storage 175° C./120 hr

| | | | Total | |
|---|---|---|---|---|
| Alloy | Cu₃Sn | Cu₆Sn₅ | CuSn | Ratio |
| Sn95.5Ag4Cu0.5 | 5 μm | 10 μm | 15 μm | 0.33 |
| Sn92.8Ag5Cu1In1Nd0.2 | 4 μm | 8 μm | 12 μm | 0.33 |
| Sn94.995Ag2.5Cu0.5In2Nd0.005 | 2 μm | 6 μm | 8 μm | 0.25 |
| Sn91.5Ag4Cu0.5In4 | 1.5 μm | 5.5 μm | 7 μm | 0.21 |
| Sn88.5Ag4Cu0.5In7 | 1 μm | 5 μm | 6 μm | 0.17 |

The improved high temperature stability finds its explanation in the properties of the CuSn phases. The hardness of Cu₃Sn equals 320 HV10 and the phase is very brittle and susceptible to fracture, while the hardness of Cu₆Sn₅ equals “only” 105 HV10 and exhibits significantly lower brittleness. For better characterizing of the resulting Cu₃Sn and Cu₆Sn₅ phases, the hardness of the metallurgically produced molten phases was determined. This procedure was selected because the hardness measurement on the metallographic micro-section in the boundary surfaces of the soldered samples produces only inexact results due to the small layer thickness of a few μm.

Thus, how thick the brittle Cu₃Sn phase forms under temperature loading is consequently crucial for high-temperature reliability. The slower the phase growth and the thinner the layer thickness of the brittle Cu₃Sn phase is, the better stresses can be dissipated in the boundary surfaces and therefore the high-temperature reliability can be increased.

Another advantage lies in that, due to the reduced phase growth, the Cu conductor tracks are converted with significant delay into CuSn phases at increased operating temperatures, also called de-alloying. If the Cu layer thickness is too small in the soldered surfaces of the conductor tracks, these separate from the carrier material, which leads to electrical failure of the component.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-11. (canceled)

12. A lead-free solder based on an Sn—In—Ag solder alloy containing:
88 to 98.5 wt. % Sn,
1 to 10 wt. % In,
0.5 to 3.5 wt. % Ag,
0 to 1 wt. % Cu, and
a doping with a crystallization modifier, which inhibits growth of intermetallic phases in the solder, when solidified.

13. The lead-free solder according to claim 1, wherein the alloy contains:
88 to 98.5 wt. % Sn,
1 to 8 wt. % In,
0.5 to 3.5 wt. % Ag,
0 to 1 wt. % Cu,
0 to 3 wt. % Ga, Sb, Bi in total,
up to 1 wt. % additives or impurities, and
a doping with a crystallization modifier.

14. The lead-free solder according to claim 12, wherein the crystallization modifier is neodymium and has a concentration of 100 ppm maximum.

15. The lead-free solder according to claim 12, wherein the alloy comprises between 1.5 and 5 wt. % indium.

16. The lead-free solder according to claim 12, wherein the alloy comprises between 1 and 3 wt. % silver.

17. The lead-free solder according to claim 12, wherein the alloy has a melting temperature above 210° C.

18. The lead-free solder according to claim 12, wherein formation of Ag₃Sn phases in the solder results with a star shape under a temperature load.

19. The lead-free solder according to claim 12, wherein the crystallization modifier is dissolved in the alloy matrix.

20. A method for production of a solder according to claim 14, comprising steps of producing a master alloy of Nd with one component of the Sn—In—Ag alloy, and diluting the master alloy in remaining components of the Sn—In—Ag alloy.

21. The lead-free solder according to claim 12, wherein the solder is present in a device in wafer bumping technology.

22. A solder point made from the lead-free solder according to claim 12, wherein the solder point is present in a device used at temperatures between 140 and 200° C.

23. The solder point according to claim 22, wherein the solder point is present in a device used at temperatures between 150 and 190° C.
